(19) United States
(12) Patent Application Publication
(10) Pub. No.: US 2025/0282922 A1
(43) Pub. Date: Sep. 11, 2025

(54) FOAMING CURABLE COMPOSITION

(71) Applicant: Sunstar Engineering Inc., Osaka (JP)

(72) Inventors: Kazuaki HANASAKI, Osaka (JP); Shuhei KONISHI, Osaka (JP); Atsushi UNO, Osaka (JP)

(73) Assignee: Sunstar Engineering Inc., Osaka (JP)

(21) Appl. No.: 18/862,529

(22) PCT Filed: Apr. 21, 2023
(86) PCT No.: PCT/JP2023/015854

§ 371 Date: Nov. 2, 2024

(30) Foreign Application Priority Data
May 11, 2022 (JP) 2022-078253

(51) Int. Cl. C08J 9/20; C08J 9/10; C08J 9/14; C08K 5/14; C08L 9/06; G10K 11/165

(52) U.S. Cl. CPC C08J 9/20; C08J 9/104; C08J 9/141; C08K 5/14; C08L 9/06; G10K 11/165; C08J 2203/04; C08J 2203/14; C08J 2203/22; C08J 2309/06; C08J 2409/00; C08J 2433/20; C08L 2203/14; C08L 2205/025; C08L 2205/03; C08L 2205/06; C08L 2205/20; C08L 2312/02

(57) ABSTRACT

Provided is a foaming curable composition containing a heat-curable elastomer (A), a chemical foaming agent (B), and expandable particles (C) having a shell and an encapsulated component, wherein the chemical foaming agent (B) contains a hydrazine-based foaming agent (B1), and the peak foaming temperature of the chemical foaming agent (B) is 5° C. to 50° C. higher than the peak expansion temperature of the expandable particles (C). This novel foaming curable composition has good foaming and adhesive properties, as well as good properties after standing uncured.

### TECHNICAL FIELD

The present disclosure relates to a foamable and curable composition, particularly a foamable and curable composition useful for enhancing sound insulation properties of an article.

### BACKGROUND ART

Voids in various articles can cause noise. For example, regarding a vehicle, air enters a cavity pillar in a vehicle component during traveling, wind noise is generated, and silence in a driving unit may be disturbed. In order to block such noise, a technique is known in which a foamable molded article is bonded in voids and then heated and foamed to fill the voids. However, there are problems on the manufacturing cost of the molded article and difficulty in automation of bonding, and therefore that technique is not necessarily economical. In addition, when a foamable molded article is used, there arises a restriction in the foaming direction, and there may be a problem that the foamable filler cannot be sufficiently filled and a sound insulation effect cannot be sufficiently exhibited. In view of such circumstances, in recent years, use of an application-type foamable filler has been studied in place of a foamable molded article.

Patent Document 1 discloses that a paste-like thermally foamable filler containing an uncrosslinked rubber, a quinone-based vulcanizer, and a foaming agent has high foaming performance even at low temperature.

### PRIOR ART DOCUMENT

### Patent Document

Patent Document 1: JP-A-2012-136135

### SUMMARY OF THE INVENTION

### Problems to be Solved by the Invention

Such conventional application-type foamable fillers, however, do not necessarily have sufficient properties after being left uncured (for example, foamability after being left uncured under high temperature conditions and/or wet conditions). When the properties after being left uncured are insufficient, workability may be deteriorated, resulting in disadvantage. Therefore, the present disclosure is intended to provide a novel foamable and curable composition being good in properties after being left uncured in addition to foaming properties and adhesive properties.

### Solutions to the Problems

The present disclosure includes the following embodiments.

### [Item 1]

A foamable and curable composition comprising:
a thermally curable elastomer (A),
a chemical foaming agent (B); and
expandable particles (C) having a shell and an enclosed component,
wherein
the chemical foaming agent (B) includes a hydrazine-based foaming agent (B1), and
a peak temperature difference defined by [a foaming peak temperature of the chemical foaming agent (B)]−[an expansion peak temperature of the expandable particles (C)] is −10° C. or more and 40° C. or less.

### [Item 2]

The foamable and curable composition of item 1, wherein the foamable and curable composition does not contain azodicarbonamide or contains azodicarbonamide less than 1% by weight in the foamable and curable composition.

### [Item 3]

The foamable and curable composition according to item 1 or 2, wherein
the enclosed component includes a hydrocarbon, and
the hydrocarbon has a boiling point of 50° C. or higher and 130° C. or lower.

### [Item 4]

The foamable and curable composition according to item 3, wherein
the enclosed component includes a hydrocarbon, and
the hydrocarbon has a boiling point of 80° C. or higher and 120° C. or lower and 7 or more and 9 or less carbon atoms.

### [Item 5]

The foamable and curable composition according to any one of items 1 to 4, wherein the enclosed component has an average boiling point of 50° C. or higher and 130° C. or lower.

### [Item 6]

The foamable and curable composition of any one of items 1 to 5, wherein the foamable and curable composition comprises a crosslinking agent (D).

### [Item 7]

The foamable and curable composition according to any one of items 1 to 6, wherein the crosslinking agent (D) includes a peroxide.

### [Item 8]

The foamable and curable composition according to any one of items 1 to 7, wherein the thermally curable elastomer (A) is a diene polymer.

### [Item 9]

The foamable and curable composition according to any one of items 1 to 8, wherein the foamable and curable composition comprises a thermoplastic resin (E) and a plasticizer (F).

### [Item 10]

The foamable and curable composition according to any one of items 1 to 9, wherein a viscosity of the foamable and curable composition at a shear rate of 20 sec⁻¹ at 23° C. is 500 Pa·s or more and 3000 Pa·s or less.

### [Item 11]

The foamable and curable composition according to any one of items 1 to 10, wherein the foamable and curable composition has an expansion ratio of 6.5 times or more and 15 times or less.

### [Item 12]

The foamable and curable composition according to any one of items 1 to 11, which is used for sound insulation.

### [Item 13]

A structure having a portion filled with the foamable and curable composition according to any one of items 1 to 12 or a foamed and cured body thereof.

### [Item 14]

The structure according to item 13, wherein the structure has a closed cross section,
the closed cross section is filled with the foamable and curable composition or a foamed and cured body thereof, and
the structure is a vehicle body member or an automobile.

### Effects of the Invention

The foamable and curable composition in the present disclosure is superior in properties after being left uncured in addition to foaming properties and adhesive properties.

### BRIEF DESCRIPTION OF THE DRAWINGS

FIG. 1 is a schematic explanatory view illustrating a test piece shape for shower resistance evaluation.

FIG. 2 is a schematic explanatory view of a shower resistance evaluation device.

FIG. 3 is a schematic explanatory view of arrangement in hat fillability evaluation.

### DETAILED DESCRIPTION

### <Foamable and Curable Composition>

The foamable and curable composition in the present disclosure comprises:
a thermally curable elastomer (A);
a chemical foaming agent (B); and
expandable particles (C) having a shell and an enclosed component.

### [Viscosity of Foamable and Curable Composition]

The viscosity of the foamable and curable composition at a shear rate of 20 sec⁻¹ at 23° C. may be 300 Pa·s or more, 500 Pa·s or more, 700 Pa·s or more, 1000 Pa·s or more, 1200 Pa·s or more, or 1500 Pa·s or more, and is preferably 500 Pa·s or more, and more preferably 700 Pa·s or more. The viscosity of the foamable and curable composition at a shear rate of 20 sec⁻¹ at 23° C. may be 3500 Pa·s or less, 3000 Pa·s or less, 2500 Pa·s or less, 2000 Pa·s or less, 1500 Pars or less, or 1200 Pa·s or less, and is preferably 3000 Pa·s or less, and more preferably 1500 Pa·s or less. When the viscosity is within the above range, automatic application of the composition is easier and the workability may be improved. The viscosity of the foamable and curable composition can be adjusted by changing the amounts of the ingredients (for example, the amount of the thermally curable elastomer (A) and the amount of the plasticizer (F)). In particular, when the viscosity is equal to or more than the lower limit described above, an expansion ratio loss due to foam breakage during foaming/expansion can be suitably inhibited, and the foaming ratio can be suitably controlled.

### [Expansion Ratio of Foamable and Curable Composition]

The expansion ratio of the foamable and curable composition may be 4 times or more, 5 times or more, 6 times or more, 7 times or more, 8 times or more, 9 times or more, 10 times or more, 11 times or more, or 12 times or more, and is preferably 5 times or more, and more preferably 6.5 times or more. The expansion ratio of the foamable and curable composition may be 25 times or less, 20 times or less, 18 times or less, 16 times or less, 14 times or less, 12 times or less, 10 times or less, or 8 times or less, and is preferably 15 times or less, and more preferably 12 times or less. When the expansion ratio is within the above range, good foamability and sufficient strength of a foamed body can be realized. Here, as curing conditions, any one among 130° C.×20 minutes, 150° C.×20 minutes, 160° C.×20 minutes, 180° C.×20 minutes, and 215° C.×20 minutes may be employed. The expansion ratio may be in the above range under at least one condition, preferably two or more, and more preferably three or more conditions (for example, three conditions of 130° C.×20 minutes, 150° C.×20 minutes, and 180° C.×20 minutes, or three conditions of 160° C.×20 minutes, 180° C.×20 minutes, and 215° C./20 minutes) among those curing conditions. The expansion ratio is preferably within the above range both before and after being left uncured.

### [(A) Thermally Curable Elastomer]

The foamable and curable composition comprises a thermally curable elastomer (A) having a reactive double bond. The “thermally curable elastomer” is a polymer in which a network structure is three-dimensionally formed by heating, and elasticity is increased or developed. Examples of the thermally curable elastomer (A) include a silicone-based elastomer, an acrylic elastomer, an epoxy-based elastomer, a fluorine-based elastomer, a urethane-based elastomer, and a diene polymer (natural rubber or synthetic rubber).

The thermally curable elastomer (A) preferably has a reactive double bond, especially, a carbon-carbon double bond, and the thermally curable elastomer (A) is preferably a diene polymer. The diene polymer may be natural rubber or synthetic rubber and may have repeating units derived from butadiene or isoprene. Specific examples of the diene polymer include an acrylonitrile-isoprene copolymer rubber (NIR), an acrylonitrile-butadiene copolymer rubber (NBR), a styrene-butadiene copolymer rubber (SBR), a butadiene rubber (BR), and an isoprene rubber (IR). The diene polymer may be an uncrosslinked rubber or a partially crosslinked rubber. The partially crosslinked rubber is a polymer obtained by partially crosslinking an uncrosslinked rubber in advance using a crosslinking agent such as divinylbenzene or sulfur. The thermally curable elastomer (A) is preferably in a solid state at normal temperature, and may be dissolved and mixed, for use, in other liquid components in the composition. By selecting the thermally curable elastomer (A) that is solid at normal temperature, it is possible to secure physical properties after curing and to hold a gas in the composition during foaming, and physical properties after curing and foaming properties can be favorably exhibited.

### (Amount of Thermally Curable Elastomer (A))

The amount of the thermally curable elastomer (A) may be 0.5% by weight or more, 1% by weight or more, 3% by weight or more, 5% by weight or more, 8% by weight or more, 10% by weight or more, 15% by weight or more, 20% by weight or more, or 25% by weight or more in the foamable and curable composition, and is preferably 3% by weight or more. The amount of the thermally curable elastomer (A) may be 50% by weight or less, 45% by weight or less, 40% by weight or less, 35% by weight or less, 30% by weight or less, 20% by weight or less, or 10% by weight or less in the foamable and curable composition, and is preferably 40% by weight or less. When the amount of the thermally curable elastomer (A) is equal to or more than the lower limit described above, the effect of inhibiting gas leakage can be favorably exhibited. When the amount of the thermally curable elastomer (A) is equal to or less than the above upper limit, good viscosity can be exhibited.

### [(B) Chemical Foaming Agent]

The foamable and curable composition in the present disclosure comprises a chemical foaming agent (B). The “chemical foaming agent” is an agent that generates gas through thermal decomposition and generates bubbles in the composition.

The chemical foaming agent (B) in the present disclosure includes a hydrazine-based foaming agent (B1). The hydrazine-based foaming agent (B1) is a compound having a hydrazide group. The hydrazine-based foaming agent (B1) may be an aromatic compound or an aliphatic compound. Specific examples of the hydrazine-based foaming agent (B1) include 4,4′-oxybis(benzenesulfonylhydrazide), diphenylsulfone-3,3′-disulfonylhydrazide, allylbis(sulfonylhydrazide), and p-toluenesulfonylhydrazide.

The foamable and curable composition in the present disclosure may comprise a chemical foaming agent (B) other than the hydrazine-based foaming agent (B1). The chemical foaming agent (B) other than the hydrazine-based foaming agent (B1) may be an organic foaming agent or an inorganic foaming agent. Examples of the organic foaming agent include azo-based foaming agents such as azodicarbonamide (ADCA), azobisformamide, and azobisisobutyronitrile; fluorinated alkane-based foaming agents such as trichloromonofluoromethane; semicarbazide-based foaming agents such as p-toluenesulfonyl semicarbazide; triazole-based foaming agents such as 5-morpholyl-1,2,3,4-thiatriazole; and N-nitroso foaming agents such as N,N-dinitrosoterephthalamide. Examples of the inorganic foaming agent include ammonium carbonate, ammonium hydrogen carbonate, ammonium nitrite, ammonium borohydride, and azides. The chemical foaming agent (B) may be used in combination with a foaming aid (for example, urea).

In the foamable and curable composition, an azo-based foaming agent such as azodicarbonamide (ADCA) is generally used in many cases because good foaming properties are exhibited. However, as ADCA is included in the SVHC (substances of very high concern) list of the REACH regulation, which is the European Chemical Regulation, there is a possibility that an azo-based foaming agent such as ADCA cannot be used, and thus a formulation that does not contain ADCA or an azo-based foaming agent is demanded. In the foamable and curable composition of the present disclosure, the amount of ADCA may be small (for example, less than 1% by weight, less than 0.7% by weight, less than 0.5% by weight, less than 0.3% by weight, less than 0.1% by weight, less than 0.05% by weight, or less than 0.01% by weight in the foamable and curable composition), and the amount of the azo-based foaming agent may be small (for example, less than 1% by weight, less than 0.7% by weight, less than 0.5% by weight, less than 0.3% by weight, less than 0.1% by weight, less than 0.05% by weight, or less than 0.01% by weight in the foamable and curable composition). The foamable and curable composition of the present disclosure may not contain ADCA or may not contain an azo-based foaming agent. The foamable and curable composition in the present disclosure can have favorable foaming properties, adhesive properties, and properties after being left uncured, and the like in combination even in a formulation not using ADCA or an azo-based foaming agent.

### (Foaming Peak Temperature of Chemical Foaming Agent (B))

The “foaming peak temperature of the chemical foaming agent (B)” refers to an exothermic peak temperature associated with foaming in a DSC curve with the horizontal axis as the temperature, obtained by DSC measurement (temperature raising rate: 20° C./min) of the foamable and curable composition containing the chemical foaming agent (B). The detailed measurement method may be as described in Examples.

The foaming peak temperature of the chemical foaming agent (B) has a certain temperature difference from the expansion peak temperature of the expandable particles (C) described later, and the peak temperature difference defined by [the foaming peak temperature of the chemical foaming agent (B)]−[the expansion peak temperature of the expandable particles (C)] is −10° C. or more and 40° C. or less. The peak temperature difference may be −10° C. or more, −5° C. or more, 0° C. or more, 1° C. or more, 3° C. or more, 5° C. or more, 10° C. or more, 15° C. or more, 20° C. or more, 25° C. or more, or 30° C. or more, and is preferably 0° C. or more or 5° C. or more. The peak temperature difference may be 40° C. or less, 30° C. or less, 20° C. or less, 10° C. or less, or 0° C. or less, and is preferably 20° C. or less. When the peak temperature difference is within the above range, foaming properties, adhesive properties, properties after being left uncured, and the like can be favorably combined.

When there are a plurality of peaks associated with foaming in the DSC curve as in the case of a combination of a plurality of types of the chemical foaming agents (B), it is just required that the temperature difference for at least one foaming peak temperature is within the above range. The peak temperature difference for the maximum foaming peak temperature and/or for the average foaming peak temperature may be in the above range. The average foaming peak temperature may refer to a sum obtained by multiplying each peak temperature of a plurality of peaks associated with foaming by its peak area ratio. For example, the peak temperature of a DSC curve including peak a (peak area: Sa, peak temperature: Ta) and peak b (peak area: Sb, peak temperature: Tb) is obtained from the formula of T=Ta×Sa/(Sa+Sb)+Tb×Sb/(Sa+Sb). A shoulder peak is also regarded as a peak, but may be ignored when the shoulder peak is significantly smaller than the main peak.

The foaming peak temperature of the chemical foaming agent (B) may be 100° C. or higher, 120° C. or higher, 140° C. or higher, 160° C. or higher, 180° C. or higher, 200° C. or higher, or 220° C. or higher. The foaming peak temperature of the chemical foaming agent (B) may be 300° C. or lower, 280° C. or lower, 260° C. or lower, 240° C. or lower, 220° C. or lower, 200° C. or lower, 180° C. or lower, or 160° C. or lower.

### (Amount of Chemical Foaming Agent (B))

The amount of the chemical foaming agent (B) may be 0.1% by weight or more, 0.5% by weight or more, 1% by weight or more, 3% by weight or more, 5% by weight or more, 8% by weight or more, 10% by weight or more, 15% by weight or more, 20% by weight or more, or 25% by weight or more in the foamable and curable composition, and is preferably 1% by weight or more. The amount of the chemical foaming agent (B) may be 45% by weight or less, 40% by weight or less, 35% by weight or less, 30% by weight or less, 20% by weight or less, or 10% by weight or less in the foamable and curable composition, and is preferably 30% by weight or less.

### (Amount of Hydrazine-Based Foaming Agent (B1))

The amount of the hydrazine-based foaming agent (B1) may be 10% by weight or more, 20% by weight or more, 40% by weight or more, 60% by weight or more, 80% by weight or more, or 95% by weight or more in the chemical foaming agent (B), and is preferably 40% by weight or more. The amount of the hydrazine-based foaming agent (B1) may be 100% by weight or less, 98% by weight or less, 90% by weight or less, 80% by weight or less, 70% by weight or less, or 60% by weight or less in the chemical foaming agent (B).

### [(C) Expandable Particles]

The foamable and curable composition in the present disclosure may comprise expandable particles (C). The expandable particles (C) have a shell and an enclosed component. When the expandable particles (C) are heated, each shell is softened, and at the same time, the enclosed component is vaporized, and the expandable particles are thermally expanded to form hollow particles (balloons).

The expandable particles are usually spherical (substantially spherical, elliptic spherical).

The average particle size of the expandable particles (C) may be 1 μm or more, 5 μm or more, 10 μm or more, 15 μm or more, 20 μm or more, 25 μm or more, 30 μm or more, 35 μm or more, 40 μm or more, or 50 μm or more, and is preferably 10 μm or more, and more preferably 20 μm or more. The average particle size of the expandable particles (C) may be 200 μm or less, 150 μm or less, 100 μm or less, 75 μm or less, 50 μm or less, 40 μm or less, or 30 μm or less, and is preferably 100 μm or less, and more preferably 75 μm or less. The average particle size may be a 50% diameter of a volume cumulative particle size distribution measured by a laser diffraction/scattering type particle size distribution analyzer.

Examples of commercially available products of the expandable particles (C) include Advancell EM series (Sekisui Chemical Co., Ltd.), Expancell DU, WU, MB, SL, FG series (AkzoNovel), Matsumoto Microsphere F, FN series (Matsumoto Yushi-Seiyaku Co., Ltd.), and Kureha Microsphere (Kureha Corporation).

### (Expansion Peak Temperature of Expandable Particles (C))

The “expansion peak temperature of the expandable particles (C)” refers to a peak temperature associated with foaming in a DSC curve with the horizontal axis as the temperature, obtained by DSC measurement (temperature raising rate: 20° C./min) of the expandable particles (C). The detailed measurement method may be as described in Examples.

The expansion peak temperature of the expandable particles (C) is lower than the foaming peak temperature of the chemical foaming agent (B), and may have a certain temperature difference from the foaming peak temperature of the chemical foaming agent (B) as explained in (Foaming peak temperature of chemical foaming agent (B)) described above.

When there are a plurality of peaks associated with expansion in the DSC curve as in the case of a combination of a plurality of types of the expandable particles (C), it is just required that the temperature difference for at least one expansion peak temperature is within the above range. The peak temperature difference for the maximum expansion peak temperature and/or for the average expansion peak temperature may be in the above range. The average expansion peak temperature may refer to a sum obtained by multiplying each peak temperature of a plurality of peaks associated with expansion by its peak area ratio. For example, the peak temperature of a DSC curve including peak a (peak area: Sa, peak temperature: Ta) and peak b (peak area: Sb, peak temperature: Tb) is obtained from the formula of T=Ta×Sa/(Sa+Sb)+Tb×Sb/(Sa+Sb). A shoulder peak is also regarded as a peak, but may be ignored when the shoulder peak is significantly smaller than the main peak.

The expansion peak temperature of the expandable particles (C) may be 80° C. or higher, 100° C. or higher, 120° C. or higher, 140° C. or higher, 160° C. or higher, 180° C. or higher, or 200° C. or higher. The expansion peak temperature of the expandable particles (C) may be 280° C. or lower, 260° C. or lower, 240° C. or lower, 220° C. or lower, 200° C. or lower, 180° C. or lower, 160° C. or lower, or 140° C. or lower.

### (Shell)

The shell constitutes an outer shell of each expandable particle (C). The shell is a material that is softened by heating, and is especially a thermoplastic resin.

The shell may have repeating units derived from monomers. The term “monomer” referred simply to as is intended to mean a (radical) polymerizable monomer having one polymerizable double bond, and is distinguished from the crosslinkable monomer described below.

The shell may have repeating units derived from a nitrile-based monomer. The nitrile-based monomer is a monomer having one or more nitrile groups per molecule. Examples of the nitrile-based monomer include acrylonitrile, methacrylonitrile, fumaronitrile, α-ethylacrylonitrile, and α-isopropylacrylonitrile. Owing to containing the nitrile-based monomer, the gas barrier properties of the thermoplastic resin constituting the outer shell can be improved.

The amount of the repeating units derived from the nitrile-based monomer may be 5% by weight or more, 15% by weight or more, 30% by weight or more, 45% by weight or more, or 60% by weight or more in the shell. The amount of the repeating units derived from the nitrile-based monomer may be 98% by weight or less, 95% by weight or less, 90% by weight or less, 80% by weight or less, 70% by weight or less, 60% by weight or less, or 50% by weight or less in the shell. The weight ratio (AN/MAN) of acrylonitrile (AN) to methacrylonitrile (MAN) may be 3/97 to 90/10, 4/96 to 70/30, or 4/96 to 60/40.

The shell may have repeating units derived from a carboxyl group-containing monomer. The carboxyl group-containing monomer is a monomer having one or more free carboxyl groups per molecule. Examples of the carboxyl group-containing monomer include unsaturated monocarboxylic acids such as acrylic acid, methacrylic acid, ethacrylic acid, crotonic acid, and cinnamic acid; unsaturated dicarboxylic acids such as maleic acid, itaconic acid, fumaric acid, citraconic acid, and chloromaleic acid, anhydrides of unsaturated dicarboxylic acids; unsaturated dicarboxylic acid monoesters such as monomethyl maleate, monoethyl maleate, monobutyl maleate, monomethyl fumarate, monoethyl fumarate, monomethyl itaconate, monoethyl itaconate, and monobutyl itaconate, and preferable examples include acrylic acid, methacrylic acid, maleic acid, maleic anhydride, and itaconic acid. More preferable examples of the carboxyl group-containing monomer include acrylic acid and methacrylic acid, and particularly preferable examples include methacrylic acid because of its high gas barrier properties. In the carboxyl group-containing monomer, some or all of the carboxyl groups may be neutralized during or after polymerization.

The amount of the repeating units derived from the carboxyl group-containing monomer may be 5% by weight or more, 15% by weight or more, 30% by weight or more, 45% by weight or more, or 60% by weight or more in the shell. The amount of the repeating units derived from the carboxyl group-containing monomer may be 98% by weight or less, 95% by weight or less, 90% by weight or less, 80% by weight or less, 70% by weight or less, 60% by weight or less, or 50% by weight or less in the shell.

The shell may have repeating units derived from other monomers. Examples of the other monomers include vinyl halide-based monomers such as vinyl chloride; vinylidene halide-based monomers such as vinylidene chloride; vinyl ester-based monomers such as vinyl acetate, vinyl propionate, and vinyl butyrate; (meth)acrylic acid ester monomers such as methyl (meth)acrylate, ethyl (meth)acrylate, n-butyl (meth)acrylate, t-butyl (meth)acrylate, 2-ethylhexyl (meth)acrylate, stearyl (meth)acrylate, phenyl (meth)acrylate, isobornyl (meth)acrylate, cyclohexyl (meth)acrylate, benzyl (meth)acrylate, and 2-hydroxyethyl (meth)acrylate; (meth)acrylamide monomers such as acrylamide, substituted acrylamides, methacrylamide, and substituted methacrylamides; maleimide-based monomers such as N-phenylmaleimide and N-cyclohexylmaleimide; styrene-based monomers such as styrene and α-methylstyrene; ethylenically unsaturated monoolefin-based monomers such as ethylene, propylene, and isobutylene; vinyl ether-based monomers such as vinyl methyl ether, vinyl ethyl ether, and vinyl isobutyl ether; vinyl ketone-based monomers such as vinyl methyl ketone; N-vinyl monomers such as N-vinylcarbazole and N-vinylpyrrolidone; and vinylnaphthalene salts.

As such other monomers, at least one selected from among (meth)acrylic acid ester-based monomers, styrene-based monomers, vinyl ester-based monomers, acrylamide-based monomers, and vinylidene halide-based monomers (especially vinylidene chloride) is preferably contained. When the shell contains repeating units derived from a vinylidene chloride-based monomer, gas barrier properties can be improved. When the shell contains repeating units derived from a (meth)acrylic acid ester-based monomer and/or a styrene-based monomer, it is easy to control thermal expansion properties. When the shell contains a (meth)acrylamide monomer as a monomer component, heat resistance can be improved.

The individual amount or the total amount of the repeating units derived from at least one selected from among the vinylidene halide-based monomers (especially vinylidene chloride), the (meth)acrylic acid ester-based monomers, the (meth)acrylamide-based monomers, and the styrene-based monomers may be 5% by weight or more, 15% by weight or more, 30% by weight or more, 45% by weight or more, or 60% by weight or more in the shell. The individual amount or the total amount of the repeating units derived from at least one selected from among the vinylidene halide-based monomers (especially vinylidene chloride), the (meth)acrylic acid ester-based monomers, the (meth)acrylamide-based monomers, and the styrene-based monomers may be 98% by weight or less, 95% by weight or less, 90% by weight or less, 80% by weight or less, 70% by weight or less, 60% by weight or less, or 50% by weight or less in the shell.

When the shell has repeating units derived from a carboxyl group-containing monomer, the shell may have repeating units derived from a monomer that reacts with the carboxyl group of the carboxyl group-containing monomer. When the repeating unit derived from the monomer that reacts with a carboxyl group is further contained, heat resistance is further improved, and expansion performance at high temperature is improved. Examples of the monomer that reacts with a carboxyl group include N-methylol (meth)acrylamide, N,N-dimethylaminoethyl (meth)acrylate, N, N-dimethylaminopropyl (meth)acrylate, vinyl glycidyl ether, propenyl glycidyl ether, glycidyl (meth)acrylate, 2-hydroxyethyl (meth)acrylate, 2-hydroxypropyl (meth)acrylate, 2-hydroxybutyl (meth)acrylate, and 2-hydroxy-3-phenoxypropyl (meth)acrylate. The amount of the repeating units derived from the monomer that reacts with a carboxyl group may be 0.1 to 10% by weight, e.g., 3 to 5% by weight, in the shell.

In addition to the monomer described above, the shell may have repeating units derived from a crosslinkable monomer having two or more polymerizable double bonds.

Examples of the crosslinkable monomer include aromatic divinyl compounds such as divinylbenzene; di(meth)acrylate compounds such as allyl methacrylate, triacrylformal, triallyl isocyanate, ethylene glycol di(meth)acrylate, diethylene glycol di(meth)acrylate, 1,4-butanediol di(meth)acrylate, 1,9-nonanediol di(meth)acrylate, PEG #200 di(meth)acrylate, PEG #600 di(meth)acrylate, trimethylolpropane trimethacrylate, pentaerythritol tri(meth)acrylate, dipentaerythritol hexaacrylate, and 2-butyl-2-ethyl-1,3-propanediol diacrylate; bisacrylamides such as N,N′-methylenebis(meth)acrylamide; di or tri(meth)acrylic acid esters obtained by reacting polyepoxide with (meth)acrylic acid; di(meth)acrylic acid carbamyl esters obtained by reacting a polyisocyanate such as tolylene diisocyanate or hexamethylene diisocyanate with hydroxyethyl (meth)acrylate; allylated starch; allylated cellulose; diallyl phthalate; and N,N′,N″-triallyl isocyanurate. These crosslinking agents may be used singly or two or more of them may be used in combination.

The amount of the repeating units derived from the crosslinkable monomer may be 0.1% by weight or more, 0.3% by weight or more, 0.5% by weight or more, 1% by weight or more, or 3% by weight or more in the shell. The amount of the repeating units derived from the crosslinkable monomer may be 10% by weight or less, 7.5% by weight or less, 5% by weight or less, 3% by weight or less, or 1% by weight or less in the shell. The range described above is suitable from the viewpoint of the expandability, heat resistance, and the like of the expandable particles (C).

### Amount of Shell

The amount of the shell may be 50% by weight or more, 60% by weight or more, 70% by weight or more, or 80% by weight or more in the expandable particles (C). The amount of the shell may be 95% by weight or less, 90% by weight or less, 80% by weight or less, 70% by weight or less, or 60% by weight or less in the expandable particles (C). The range described above is suitable from the viewpoint of the expandability, heat resistance, and the like of the expandable particles (C).

### (Enclosed Component)

The enclosed component is a substance that is vaporized by heating, and functions as an expander in the expandable particles (C).

The enclosed component constituting the expandable particles (C) may be any substance that is vaporized by being heated. Examples of the enclosed component include hydrocarbons having 3 to 13 carbon atoms such as propane, butane, pentane, hexane, heptane, octane, nonane, decane, undecane, dodecane, tridecane, and structural isomers thereof; hydrocarbons having more than 13 and 20 or less carbon atoms such as hexadecane, eicosane, and structural isomers thereof; hydrocarbons from petroleum fractions such as pseudocumene, petroleum ether, and normal paraffins and isoparaffins having an initial boiling point ranging from 150 to 260° C. and/or being distilled at a temperature ranging from 70 to 360° C.; their halides; fluorine-containing compounds such as hydrofluoroether; tetraalkylsilanes; and compounds which are thermally decomposed by being heated to generate gases. These enclosed components may be used singly or two or more of them may be used in combination. The enclosed component may be linear, branched, or alicyclic, and is preferably aliphatic.

The average boiling point of the enclosed component may be 40° C. or higher, 50° C. or higher, 60° C. or higher, 70° C. or higher, 80° C. or higher, or 90° C. or higher, and is preferably 50° C. or higher, and more preferably 80° C. or higher. The average boiling point of the enclosed component may be 150° C. or lower, 140° C. or lower, 130° C. or lower, 120° C. or lower, 110° C. or lower, or 100° C. or lower, and is preferably 130° C. or lower, and more preferably 120° C. or lower. The “average boiling point” refers to the sum of values obtained by multiplying the boiling points of the respective components in the enclosed component by their mass fractions. For example, the average boiling point T of a mixed solvent composed of solvent a (mass: Ma, boiling point: Ta) and solvent b (mass: Mb, boiling point: Tb) is determined from the formula of T=Ta×Ma/(Ma+Mb)+Tb×Mb/(Ma+Mb). In the present description, the boiling point refers to a boiling point at normal pressure.

The enclosed component preferably includes a hydrocarbon. The hydrocarbon included in the enclosed component may satisfy any one or both of the following features (1) and (2),
(1) having a boiling point of 50° C. or higher and 130° C. or lower,
(2) having 7 or more and 9 or less carbon atoms.

### (1) Hydrocarbon Having a Boiling Point of 50° C. Or Higher and 130° C. Or Lower

The enclosed component preferably includes a hydrocarbon having a boiling point of 50° C. or higher and 130° C. or lower. The hydrocarbon having a boiling point of 50° C. or higher and 130° C. or lower is preferably an aliphatic hydrocarbon, particularly preferably a saturated aliphatic hydrocarbon. The boiling point of the hydrocarbon having a boiling point of 50° C. or higher and 130° C. or lower may be 50° C. or higher, 60° C. or higher, 70° C. or higher, 80° C. or higher, 85° C. or higher, 90° C. or higher, or 95° C. or higher, and is preferably 90° C. or higher. The boiling point of the hydrocarbon having a boiling point of 50° C. or higher and 130° C. or lower may be 130° C. or lower, 120° C. or lower, 115° C. or lower, 110° C. or lower, 105° C. or lower, or 100° C. or lower, and is preferably 110° C. or lower. The hydrocarbon having a boiling point of 50° C. or higher and 130° C. or lower may be linear, branched, or cyclic. When the enclosed component includes a hydrocarbon having a boiling point within the above range, expansion properties, adhesive properties, properties after being left uncured, etc. can be favorably exhibited.

The amount of the hydrocarbon having a boiling point of 50° C. or higher and 130° C. or lower may be 5% by weight or more, 10% by weight or more, 20% by weight or more, 40% by weight or more, or 60% by weight or more in the enclosed component. The amount of the hydrocarbon having a boiling point of 50° C. or more and 130° C. or less may be 95% by weight or less, 80% by weight or less, 70% by weight or less, 65% by weight, 50% by weight or less, or 30% by weight or less.

### (2) Hydrocarbon Having 7 or More and 9 or Less Carbon Atoms

The enclosed component may include a hydrocarbon that may have 7 or more and 9 or less carbon atoms, and preferably has 8 carbon atoms. The hydrocarbon having 7 or more and 9 or less carbon atoms is preferably an aliphatic hydrocarbon, particularly preferably a saturated aliphatic hydrocarbon. The hydrocarbon having 6 or more and 10 or less carbon atoms may be linear, branched, or cyclic. Preferred specific examples of the hydrocarbon having 7 or more and 9 or less carbon atoms include linear or branched structural isomers of heptane such as n-heptane, 2-methylhexane, 3-methylhexane, 3-ethylpentane, 2,2-dimethylpentane, 2,3-dimethylpentane, 2,4-dimethylpentane, 3,3-dimethylpentane, and 2,2,3-trimethylbutane; linear or branched structural isomers of octane such as n-octane, 2-methylheptane, 3-methylheptane, 4-methylheptane, 2,2-dimethylhexane, 2,3-dimethylhexane, 2,4-dimethylhexane, 2,5-dimethylhexane, 3,3-dimethylhexane, 3,4-dimethylhexane, 3-ethylhexane, 2,2,3-trimethylpentane, and 2,2,4-trimethylpentane (isooctane); and linear or branched structural isomers of nonane such as 2,3,3-trimethylpentane, 2,3,4-trimethylpentane, 2-methyl-3-ethylpentane, 3-methyl-3-ethylpentane, 2,2,3,3-tetramethylbutane, n-nonane, methyloctane, dimethylheptane, ethylheptane, trimethylhexane, ethylmethylhexane, tetramethylpentane, ethyldimethylpentane, and diethylpentane. When a hydrocarbon having 7 or more and 9 or less carbon atoms (preferably, having 8 carbon atoms) is contained, expansion properties, adhesive properties, properties after being left uncured, etc. can be favorably exhibited.

Preferably, the amount of the hydrocarbon having 7 or more and 9 or less carbon atoms may be 5% by weight or more, 10% by weight or more, 20% by weight or more, 40% by weight or more, or 60% by weight or more in the enclosed component. The amount of the hydrocarbon having 6 or more and 10 or less carbon atoms (preferably the hydrocarbon having 7 or more and 9 or less carbon atoms) may be 95% by weight or less, 80% by weight or less, 70% by weight or less, 65% by weight, 50% by weight or less, or 30% by weight or less.

### Amount of Enclosed Component

The amount of the enclosed component may be 5% by weight or more, 10% by weight or more, 15% by weight or more, 20% by weight or more, 25% by weight or more, or 30% by weight or more in the expandable particles (C). The amount of the enclosed component may be 65% by weight or less, 55% by weight or less, 45% by weight or less, 35% by weight or less, or 25% by weight or less in the expandable particles (C). The range described above is suitable from the viewpoint of the expandability, heat resistance, and the like of the expandable particles (C).

### (Method for Producing Expandable Particles (C))

The method for producing the expandable particles (C) is not limited, and a known method can be used. The method for producing the thermally expandable particles (C) may be typically a method in which the above-described monomer is polymerized together with a crosslinking agent, as necessary, in the presence of an enclosed component as an expander by an in situ polymerization method, and the enclosed component is microencapsulated with a polymer. For example, JP-A-2015-3951, JP-A-2015-021066, etc. can be referred to.

### (Amount of Expandable Particles (C))

The amount of the expandable particles (C) may be 0.1% by weight or more, 0.5% by weight or more, 1% by weight or more, 3% by weight or more, 5% by weight or more, 8% by weight or more, 10% by weight or more, 15% by weight or more, 20% by weight or more, or 25% by weight or more in the foamable and curable composition, and is preferably 1% by weight or more. The amount of the expandable particles (C) may be 45% by weight or less, 40% by weight or less, 35% by weight or less, 30% by weight or less, 20% by weight or less, or 10% by weight or less in the foamable and curable composition, and is preferably 30% by weight or less.

### [(D) Crosslinking Agent]

The foamable and curable composition in the present disclosure may comprise a crosslinking agent (D). The crosslinking agent (D) is activated by heating, and can crosslink a thermally curable elastomer (especially, a diene polymer). Examples of the crosslinking agent (D) include sulfur, sulfur compounds, oximes, nitroso compounds, quinone-based compounds, polyamines, and peroxides (particularly, organic peroxides). The crosslinking agent (D) may be used in combination with a crosslinking aid (zinc oxide or the like).

The crosslinking agent (D) preferably includes an organic peroxide. Examples of the organic peroxide include ketone peroxide, peroxyketal, hydroperoxide, dialkylperoxide, facil peroxide, peroxyester, and peroxy dicarbonate, and specific examples include tert-butyl hydroperoxide, p-menthane hydroperoxide, dicumyl peroxide, tert-butyl peroxide, 1,3-bis(tert-butylperoxyisopropyl)benzene, 2,5-dimethyl-2,5-di(tert-butylperoxy) hexane, benzoyl peroxide, and tert-butyl peroxybenzoate.

### (Amount of Crosslinking Agent (D))

The amount of the crosslinking agent (D) may be 0.01% by weight or more, 0.1% by weight or more, 0.3% by weight or more, 0.5% by weight or more, 1% by weight or more, 3% by weight or more, 5% by weight or more, 8% by weight or more, or 10% by weight or more in the foamable and curable composition, and is preferably 0.1% by weight or more. The amount of the crosslinking agent (D) may be 25% by weight or less, 20% by weight or less, 10% by weight or less, 5% by weight or less, 2.5% by weight or less, or 1% by weight or less in the foamable and curable composition, and is preferably 5% by weight or less.

### [(E) Thermoplastic Resin]

The foamable and curable composition in the present disclosure may comprise a thermoplastic resin (E). The thermoplastic resin (E) is a resin that exists in the form of particles at normal temperature and can be swollen and dissolved in the plasticizer by heating. Specific examples thereof include resin particles of acrylic resin containing a polymer of an alkyl acrylate (the alkyl is methyl, ethyl, butyl, 2-ethylhexyl, or the like) or an alkyl methacrylate (the alkyl is methyl, ethyl, butyl, lauryl, stearyl, or the like) or a copolymer of the alkyl acrylate or the alkyl methacrylate with another acrylic monomer; MBS resin (methyl methacrylate/butadiene/styrene); ionomer resin; AAS resin (acrylonitrile/styrene/special rubber); AES resin (acrylonitrile/EPDM/styrene); AS resin (acrylonitrile/styrene), ABS resin (acrylonitrile/butadiene/styrene); polyurethane resin; polyester resin; vinyl chloride resin or vinylidene chloride resin (polyvinyl chloride, vinyl chloride-vinyl acetate copolymer, polyvinylidene chloride, vinylidene chloride-vinyl acetate copolymer, vinylidene chloride-vinyl chloride copolymer, etc.); or vinyl acetate resin (ethylene-vinyl acetate copolymer, vinyl acetate-acrylic acid ester copolymer, vinyl chloride-vinyl acetate copolymer).

The thermoplastic resin (E) may have a core-shell structure, and may be, for example, an acrylic resin having a core-shell structure. The core-shell structure may be composed of a shell having a relatively high glass transition temperature (Tg) and a core having a glass transition temperature (Tg) relatively lower than that of the shell. Examples thereof include those in which the glass transition temperature (Tg) of the shell is 75 to 115° C. and the glass transition temperature (Tg) of the core is 50 to 95° C. The core may be a copolymer of methyl methacrylate and an alkyl acrylate having 2 to 8 carbon atoms (C₂ to C₈) or various esters, and the shell may be methyl methacrylate alone, a copolymer of methyl methacrylate with acrylic acid, a copolymer of methyl methacrylate, a C₂ to C₈ alkyl acrylate, and acrylic acid, or the like. Examples of the product of the thermoplastic resin (E) having a core-shell structure include DIANAL LP-3106 (core-shell structure, core Tg: 75° C., shell Tg: 85° C., primary particle size: 70 μm) and DIANAL LP-3202 (core-shell structure, core Tg: 85° C., shell Tg: 95° C., primary particle size: 60 μm).

### (Amount of Thermoplastic Resin (E))

The amount of the thermoplastic resin (E) may be 0.1% by weight or more, 0.3% by weight or more, 0.5% by weight or more, 1% by weight or more, 3% by weight or more, 5% by weight or more, 8% by weight or more, or 10% by weight or more in the foamable and curable composition, and is preferably 0.5% by weight or more. The amount of the thermoplastic resin (E) may be 25% by weight or less, 20% by weight or less, 10% by weight or less, 5% by weight or less, 2.5% by weight or less, or 1% by weight or less in the foamable and curable composition, preferably 10% by weight or less. When the amount of the additive is within the above range, the cohesive force of the composition at the time of foaming is moderate, and the expansion ratio tends to be good.

### [(F) Plasticizer]

The foamable and curable composition in the present disclosure may comprise a plasticizer (F). The foamable and curable composition in the present disclosure may comprise both the thermoplastic resin (E) and the plasticizer (F). As a result, foaming properties, adhesive properties, properties after being left uncured, and the like can be favorably combined. The plasticizer in the present disclosure may be one capable of swelling or dissolving the thermally curable elastomer (A) or the thermoplastic resin (E). Examples of the plasticizer include phthalic acid esters such as di(2-ethylhexyl) phthalate, butyl benzyl phthalate, dinonyl phthalate, diisononyl phthalate, diisodecyl phthalate, diundecyl phthalate, diheptyl phthalate, and butyl phthalyl butyl glycolate; aliphatic dibasic acid esters such as dioctyl adipate, didecyl adipate, and dioctyl sebacate; polyglycol benzoic acid esters such as polyoxyethylene glycol dibenzoate and polyoxypropylene glycol dibenzoate; phosphoric acid esters such as tributyl phosphate and tricresyl phosphate; and hydrocarbons such as alkyl-substituted diphenyl, alkyl-substituted terphenyl, partially hydrogenated alkyl terphenyl, aromatic process oil, and pine oil.

### (Amount of Plasticizer (F))

The amount of the plasticizer (F) may be 3% by weight or more, 5% by weight or more, 10% by weight or more, 20% by weight or more, 30% by weight or more, 40% by weight or more, or 50% by weight or more in the foamable and curable composition, and is preferably 20% by weight or more. The amount of the plasticizer (F) may be 60% by weight or less, 50% by weight or less, 40% by weight or less, 30% by weight or less, 20% by weight or less, or 10% by weight or less in the foamable and curable composition, and is preferably 50% by weight or less.

### [(G) Filler]

The foamable and curable composition in the present disclosure may comprise a filler (G). Adhesion, sagging property, specific gravity, and the like can be adjusted by adding the filler. Examples of the filler (G) include heavy calcium carbonate, surface-untreated calcium carbonate, surface-treated calcium carbonate (for example, fatty acid-treated calcium carbonate), fumed silica, hydrophobic silica, precipitated silica, carbon black, talc, mica, clay, glass beads; balloons such as microballoon, shirasu balloon, glass balloon, silica balloon, plastic balloon, and organic powder-coated plastic balloon; plastic particles; inorganic fibers such as glass fibers, and metal fibers; organic fibers such as polyethylene fibers and polypropylene fibers; aluminum borate, silicon carbide, silicon nitride, potassium titanate, graphite; needle-like crystalline fillers such as needle-like crystalline calcium carbonate, magnesium borate, titanium diboride, chrysotile, and wollastonite; aluminum flake, aluminum powder, and iron powder. These may be used alone, or two or more thereof may be used in combination. Owing to containing the filler (G), both a shape retaining property and a foam breakage inhibition property can be favorably exhibited.

### (Amount of Filler (G))

The amount of the filler (G) may be 5% by weight or more, 10% by weight or more, 20% by weight or more, 30% by weight or more, 40% by weight or more, 50% by weight or more, or 60% by weight or more in an adhesive, and is preferably 10% by weight or more. The amount of the filler (G) may be 80% by weight or less, 70% by weight or less, 60% by weight or less, 50% by weight or less, 40% by weight or less, or 30% by weight or less in the adhesive, and is preferably 60% by weight or less. Within the above range, both the shape retaining property and the foam breakage inhibition property can be favorably exhibited.

### [(H) Other Components]

The foamable and curable composition in the present disclosure may comprise other components (H) in addition to the above components. Examples of such other components (H) include colorants; organic solvents (methanol, ethanol, isopropyl alcohol, butanol, acetone, methyl ethyl ketone, ligroin, ethyl acetate, tetrahydrofuran, n-hexane, heptane, isoparaffin-based high-boiling-point solvents, etc.); foaming aids (salicylic acid, urea, etc.); bonding agents (silane coupling agents such as vinyltrimethoxysilane, vinyltriethoxysilane, aminosilane, mercaptosilane, and epoxysilane; epoxy compounds such as glycidyl ether having a polyoxyalkylene skeleton; etc.); vulcanization accelerators (guanidines, aldehyde-amines, aldehyde-ammonias, thiazoles, sulfenamides, thioureas, thiurams, dithiocarbamates, xanthates, etc.); vulcanization aids (long-chain fatty acids having 12 or more carbon atoms such as stearic acid, oleic acid, and palmitic acid, and metal oxides such as zinc oxide, magnesium oxide, and lead oxide); antiaging agents (hindered phenols, mercaptans, sulfides, dithiocarboxylates, thioureas, thiophosphates, thioaldehydes, etc.); rehydration agents (water, hydrates of inorganic salts, etc.); ultraviolet absorbers/light stabilizers (benzotriazoles, hindered amines, etc.); antioxidants (hindered phenols, etc.); thixotropic agents (colloidal silica, organic bentonite, fatty acid amides, hydrogenated castor oil, etc.), and polymer components other than the above (thermosetting resin, thermoplastic resin, etc.). These may be used alone, or two or more thereof may be used in combination.

### (Amount of Other Components (H))

The amount of the other components (H) may be appropriately selected according to each component. For example, the total amount or the individual amount of the other components (H) may be 0.1% by weight or more, 0.5% by weight or more, 1% by weight or more, 3% by weight or more, 5% by weight or more, or 10% by weight or more in the foamable and curable composition. The total amount or the individual amount of the other components (H) may be 20% by weight or less, 15% by weight or less, 10% by weight or less, 5% by weight or less, 2.5% by weight or less, or 1% by weight or less based on the foamable and curable composition.

### [Method for Preparing Foamable and Curable Composition]

The method for preparing the foamable and curable composition may be any method as long as various components can be uniformly dispersed and mixed, and for example, a method of kneading the components using a mixer such as a planetary mixer can be used. Defoaming may be performed, as necessary, in the preparation.

### [Uses of Foamable and Curable Composition]

The foamable and curable composition in the present disclosure can be suitably used as an application-type sound insulation material to be used for manufacturing a sound insulation wall in an article in order to enhance the sound insulation property of the article. For example, the foamable and curable composition in the present disclosure is suitably used, in the production of a vehicle body member, for forming a sound insulation wall on a closed cross section where noise such as wind noise is generated during traveling. Since the foamable and curable composition in the present disclosure can be applied, this composition is superior to molded articles in that it can be automatically applied, that it can deal with voids of various shapes, that it can reduce waste such as release paper, and the like.

### <Structure and Method for Manufacturing Structure>

The structure in the present disclosure has portions filled with the foamable and curable composition described above or a foamed and cured body thereof. After the foamable and curable composition is applied to inner surfaces of voids, the foamable and curable composition is heated to a curing temperature, and is foamed and cured to fill the voids and form a sound insulation wall. From the viewpoint of the sound insulation effect, it is preferable that voids are filled without allowing gaps to remain after foaming of the foamable and curable composition.

The application may be performed by automatic application by a robot or the like. For example, the robot may include an arm, a pump, a nozzle, a valve, a material container, etc. The foamable and curable composition in the present disclosure can be superior in separability (thread breakage tendency) between the thermally foaming filler and the nozzle in the nozzle in automatic application.

The curing temperature may be 100° C. or higher, 120° C. or higher, 140° C. or higher, 160° C. or higher, or 170° C. or higher, and may be 250° C. or lower, 200° C. or lower, 170° C. or lower, 150° C. or lower, or 130° C. or lower. The curing time (heating time) may be appropriately set so as to optimize the expansion ratio and curability, but may be usually 1 minute or more, 3 minutes or more, 5 minutes or more, 10 minutes or more, or 15 minutes or more, and may be 120 minutes or less, 60 minutes or less, 30 minutes or less, or 15 minutes or less. These conditions vary depending on the setting of the manufacturing process and a substrate, and can be appropriately adjusted. Although the curing temperature for foaming and curing the foamable and curable composition of the present disclosure is usually about 180° C., the foaming and curing is sometimes performed at a low temperature such as 160° C. due to the recent trend of energy saving. For example, in the case of application to a vehicle body, the temperature does not rise due to the structure of the vehicle body, and the curing temperature is sometimes a relatively low temperature such as 150° C. or 130° C. Therefore, such a low temperature may be adopted as the curing temperature. The foamable and curable composition of the present disclosure exhibits good foaming properties and curing properties even in low temperature curing.

Examples of the substrate to be applied include inorganic substrates such as glass, glass ceramic, concrete, mortar, brick, tile, gypsum, and natural stone (for example, granite or marble); metal or alloy such as steel, aluminum, iron, copper, titanium, magnesium, or plated metal; organic substrates such as wood, various resins (PVC, polycarbonate, PMMA, polyester, epoxy resin, etc.), glass fiber-reinforced plastic (GFP), and carbon fiber-reinforced plastic (CFP); coated substrates such as a powder-coated metal or resin.

Examples of the structure may be an article having a void portion, in particular an article having a void portion of a closed cross section structure. Specific examples of the structure include a vehicle body member, an industrial machine, a home electric appliance, a building member, and the like, and preferably include vehicle body members, such as a front pillar (A pillar), a center pillar (B pillar), a rear pillar (C pillar), a wheel arch (tire house), and a side sill, and automobiles.

Although the embodiments have been described above, it will be understood that various changes in form and details can be made without departing from the spirit and scope of the claims.

### EXAMPLES

Hereinafter, the present disclosure will be described in detail with reference to Examples, but the present disclosure is not limited to these Examples.

### [Evaluation Tests]

The evaluation test procedures are as follows.

### (Foaming Peak Temperature of Chemical Foaming Agent)

Using the compositions of Examples and Comparative Examples as samples, the compositions were heated from 25° C. to 250° C. at a rate of 20° C./min using Q2000 manufactured by TA Instruments Japan Inc., and the decomposition exothermic peak temperature was taken as the foaming peak temperature of the chemical foaming agent.

### (Expansion Peak Temperature of Expandable Particles)

Using the respective lots of expandable particles as samples, each lot of expandable particles was heated from 25° C. to 250° C. at a rate of 20° C./min using Q2000 manufactured by TA Instruments Japan Inc., and the endothermic peak temperature was taken as the expansion peak temperature of the expandable particles.

### (Peak Temperature Difference)

The peak temperature difference is determined by [the foaming peak temperature of a chemical foaming agent]−[the expansion peak temperature of expandable particles].

### (Viscosity)

Using an extrusion viscometer (ASTM D1092), the viscosity at a shear rate of 20 sec⁻¹ is determined under an environment of 23° C. and 50% RH.

### (Expansion Ratio (Initial))

The composition is applied in the form of a 100×100×1.5 mm thick sheet to the center of a 300×300×0.8 mm thick steel plate. The resulting film is foamed and cured at a curing temperature described in Table 2 for 20 minutes, and a maximum foaming thickness after 1 bour from standing at normal temperature is measured and an expansion ratio is determined from the thickness before foaming.
Thickness at the time of application: t1
Thickness after curing and cooling: 12
Expansion ratio=t2/t1

### (Leaving Uncured Test, 50° C.×95% Humidity×30 Days)

The material applied in the same manner as described above is left standing at 50° C. and 95% humidity for 30 days, and then foamed and cured at a curing temperature described in Table 2 for 20 minutes, and then an expansion ratio is determined.

### (Adhesion)

Using a steel sheet sized 25×100×1 mm thick, curing is performed at a spacer thickness of 3 mm, a lap margin of 25×25 mm, a material application thickness of 1.5 mm, and a curing temperature described in Table 2 for 20 minutes. Shear strength was measured in accordance with JASO M323-77, Clause 9.20, the shear adhesion testing method.

### (Heat Aging Resistance Test)

The test piece prepared and cured for the evaluation of adhesion was left standing at 80° C. for 30 days, then taken out, further left standing at 23° C. and 50% humidity for 24 hours, and then the shear strength was measured.

### (Shower Resistance)

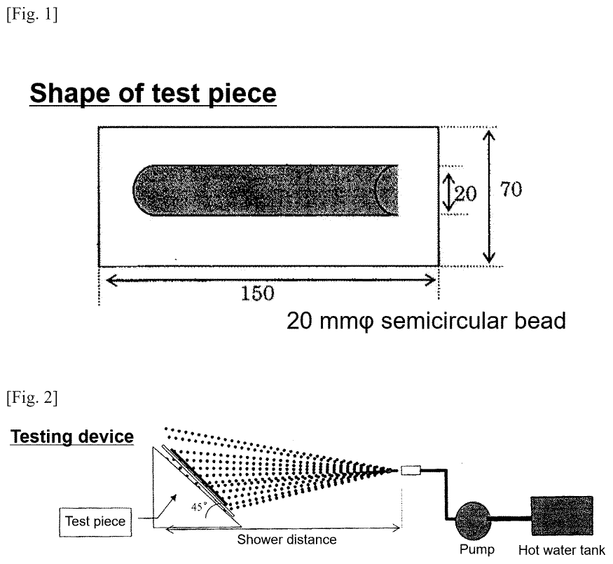

For a test piece with a test material applied at about 20 mmφ as illustrated in FIG. 1, shower resistance was evaluated under the following conditions using a testing device illustrated in FIG. 2.
Shower temperature: 50° C.
Shower angle: 45°
Shower pressure: 3 kgf/cm²
Shower time: 1 minute
Nozzle: Type K-9S PT ¼×5.0 manufactured by Katorigumi Seisakusho, K.K.
∘: The material fixing rate is 95% or more
x: The material fixing rate is less than 95%

### (Hat Fillability)

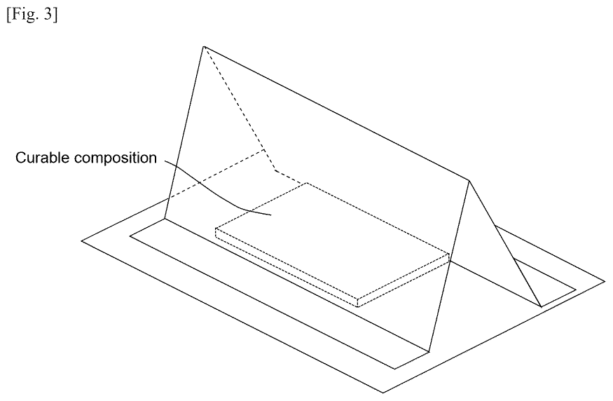

A material is applied onto a 200×200×0.8 mm thick steel plate in a shape of 45×100 mm and disposed as illustrated in FIG. 3. The triangular shape is set to be an equilateral triangle having a height of 40 mm. Curing is performed at the curing temperature described in Table 2 for 20 minutes, and the fillability at the triangular tip is checked. In the evaluation, the thickness of the applied shape was set to 5 mm for samples with a standard expansion ratio of 7.5 or more, and 6 mm for samples with a standard expansion ratio of less than 7.5.
⊙: 100% Completely filled
∘: Almost completely filled (filled 98% or more) including a triangular corner part
Δ: A gap is formed in a part of a corner part (filled 90% or more)
x: An unfilled part is formed (filled less than 90%)

### [Raw Materials]

The details of the raw materials used are as follows.

| | | |
|---|---|---|
| A1 | ISP #1009OC | Partially crosslinked rubber SBR manufactured by ISP Japan Ltd. |
| A2 | Ubepol BR130R | Uncrosslinked rubber butadiene rubber manufactured by |
| | | Ube Industries, Ltd. |
| F | DINP | Diisononyl phthalate manufactured by J-PLUS Co., Ltd. |
| D1 | PERHEXA V | n-Butyl 4,4′-di(t-butylperoxy)valerate, molecular weight: 344.46, |
| | | manufactured by NOF Corporation |
| D2 | PERBUTYL Z | t-Butyl peroxybenzoate |
| D3 | VULNOC GM | p-Quinone dioxime manufactured by Ouchi Shinko Chemical |
| | | Industrial Co., Ltd. |
| C1 | Expandable particles 1 | Average particle size: 35 to 50 μm, expansion onset temperature: 140 |
| | Matsumoto Microsphere | to 150° C., manufactured by Matsumoto Yushi-Seiyaku Co., Ltd. |
| | FN-185LD | |
| C2 | Expandable particles 2 | Isooctane 13%, average particle size: 30 to 45 μm, DSC measurement |
| | | peak temperature: 155° C. |
| C3 | Expandable particles 3 | Isooctane 10%, isopentane 3%, average particle size: 35 to 50 μm, |
| | | DSC measurement peak temperature: 150° C. |
| C4 | Expandable particles 4 | Heptane 13%, average particle size: 30 to 45 μm, DSC measurement |
| | | peak temperature: 125° C. |
| C5 | Expandable particles 5 | Octane 15%, average particle size: 35 to 50 μm, DSC measurement |
| | | peak temperature: 160° C. |
| C6 | Expandable particles 6 | 2,2-Dimethylpentane 8%, isopentane 2%, average particle size: 30 to |
| | | 45 μm, DSC measurement peak temperature: 120° C. |
| C7 | Expandable particles 7 | Softening point: 98° C., manufactured by Japan Fillite Co., Ltd. |
| | EXPANCEL 461DU | |
| C8 | Expandable particles 8 | Isobutane 20%, average particle size: 30 to 45 μm, DSC measurement |
| | | peak temperature: 90° C. |
| C9 | Expandable particles 9 | Softening point: 123° C., manufactured by Japan Fillite Co., Ltd. |
| | EXPANCEL 920DE | |
| E1 | DIANAL LP-3106 | Manufactured by Mitsubishi Chemical Corporation |
| G1 | Calcium carbonate heavy | Heavy calcium carbonate, manufactured by Bihoku Funka Kogyo Co., |
| | 300M | Ltd. |
| G2 | HAKUENKA CC | Synthetic calcium carbonate, manufactured by Shiraishi Kogyo |
| | | Kaisha, Ltd. |
| B1 | NEOCELLBORN | 4,4′-Oxybis(benzenesulfonylhydrazide), median diameter: 4 μm, |
| | #1000M | manufactured by Eiwa Chemical Ind. Co., Ltd. |
| B2 | CELLMIC C-1 | Azodicarbonamide, average particle size: 8 μm, manufactured by |
| | | Sankyo Kasei Co., Ltd. |
| B′ | CELLTON NP | Urea, manufactured by Sankyo Kasei Co., Ltd. |
| H1 | Two types of zinc oxides | Zinc oxide, manufactured by Seido Chemical Industry Co., Ltd. |
| H2 | Other additives | Kneaded product of DINP and carbon, fumed silica AEROSIL 200 |
| | | manufactured by Nippon Aerosil Co., Ltd., etc. |
| H3 | Adhesive agent | Silane coupling agent KBM-503 |
| | | (manufactured by Shin-Etsu Chemical Co., Ltd.) |

Expandable particles 2 to 6 and 8 were produced by the methods described below in accordance with the production method of JP-A-2015 003951, but the method for producing expandable particles is not limited to the following methods.

### (Method for Producing Expandable Particles 2)

The following polymerizable monomer, the following polymerization catalyst, and the following enclosed component were mixed, affording an oily mixture.

Polymerizable monomer: 96 parts of acrylonitrile, 141 parts of methacrylonitrile, 15 parts of methyl methacrylate, 5 parts of isobornyl methacrylate, 0.9 parts of trimethylolpropane triacrylate, and 0.2 parts of 1,9-nonanediol dimethacrylate

Polymerization catalyst (initiator): 1.5 parts of 1,1′-azobis(cyclohexane-1-carbonitrile) and 1.5 parts of dilauryl peroxide
Enclosed component: 40 parts of isooctane

1000 g of a colloidal aqueous dispersion medium containing about 1% of particulate magnesium hydroxide adjusted to pH 9.8 and the oily mixture were stirred with a homomixer to prepare a suspension, and a reaction was performed at an initial reaction pressure of 0.3 MPa, and initially at a polymerization temperature of 65° C. for 18 hours and subsequently at 80° C. for 2 hours, affording an aqueous dispersion medium containing thermally expandable microspheres. Then, thermally expandable microspheres (expandable particles 2) from which impurities were removed were obtained through pH adjusting treatment, water washing, filtration, and drying.

### (Method for Producing Expandable Fine Particles 3)

Thermally expandable microspheres were obtained in the same manner as the method for producing expandable particles 2 except that the polymerizable monomer, the polymerization catalyst, and the enclosed component were changed as follows.

Polymerizable monomer: 96 parts of acrylonitrile, 141 parts of methacrylonitrile, 15 parts of methyl methacrylate, 5 parts of isobornyl methacrylate, 0.9 parts of trimethylolpropane triacrylate, and 0.2 parts of 1,9-nonanediol dimethacrylate

Enclosed component: 30 parts of isooctane and 10 parts of isopentane

### (Method for Producing Expandable Fine Particles 4)

Thermally expandable microspheres were obtained in the same manner as the method for producing expandable particles 2 except that the polymerizable monomer, the polymerization catalyst, and the enclosed component were changed as follows.

Polymerizable monomer: 116 parts of acrylonitrile, 121 parts of methacrylonitrile, 20 parts of methyl methacrylate, and 1 part of trimethylolpropane triacrylate

Enclosed component: 30 parts of heptane

### (Method for Producing Expandable Fine Particles 5)

Thermally expandable microspheres were obtained in the same manner as the method for producing expandable particles 2 except that the polymerizable monomer, the polymerization catalyst, and the enclosed component were changed as follows.

Polymerizable monomer: 96 parts of acrylonitrile, 141 parts of methacrylonitrile, 15 parts of methyl methacrylate, 5 parts of isobornyl methacrylate, 0.9 parts of trimethylolpropane triacrylate, and 0.2 parts of 1,9-nonanediol dimethacrylate

Enclosed component: 50 parts of octane

### (Method for Producing Expandable Fine Particles 6)

Thermally expandable microspheres were obtained in the same manner as the method for producing expandable particles 2 except that the polymerizable monomer, the polymerization catalyst, and the enclosed component were changed as follows.

Polymerizable monomer: 116 parts of acrylonitrile, 121 parts of methacrylonitrile, 20 parts of methyl methacrylate, and 1 part of trimethylolpropane triacrylate

Enclosed component: 20 parts of 2,2′-dimethyloctane and 5 parts of isopentane

### (Method for Producing Expandable Fine Particles 8)

Thermally expandable microspheres were obtained in the same manner as the method for producing expandable particles 2 except that the polymerizable monomer, the polymerization catalyst, and the enclosed component were changed as follows.

Polymerizable monomer: 170 parts of acrylonitrile, 67 parts of methacrylonitrile, 20 parts of methyl methacrylate, and 1 part of ethylene glycol dimethacrylate

Enclosed component: 20 parts of isobutane

### Examples 1 to 11 and Comparative Examples 1 to 5

The components were mixed in accordance with the formulation given in the following Table 1, affording a foamable and curable composition. The evaluation tests described above were performed using the foamable and curable composition obtained. The results are shown in the following Table 2.

TABLE 1

| | | Example | | | | | | | | | | | Comparative Example | | | | |
|---|---|---|---|---|---|---|---|---|---|---|---|---|---|---|---|---|---|
| | Product name | 1 | 2 | 3 | 4 | 5 | 6 | 7 | 8 | 9 | 10 | 11 | 1 | 2 | 3 | 4 | 5 |
| A1 | 1009OC | 7 | 7 | 7 | 7 | 7 | 7 | 7 | 7 | 7 | 7 | 7 | 7 | 7 | 7 | 7 | 8 |
| A2 | BR130B | 5 | 5 | 5 | 5 | 5 | 5 | 5 | 5 | 5 | 5 | 5 | 5 | 5 | 5 | 5 | 4 |
| F1 | DINP | 38 | 38 | 38 | 38 | 38 | 38 | 38 | 38 | 38 | 38 | 38 | 38 | 38 | 38 | 38 | 38 |
| D1 | PERHEXA V | 0.5 | 0.5 | 0.5 | 0.5 | 0.5 | 0.5 | | | 0.5 | 0.5 | 0.5 | 0.5 | 0.5 | 0.5 | 0.5 | |
| D2 | PERBUTYL Z | | | | | | | 0.5 | 0.5 | | | | | | | | |
| D3 | VULNOC GM | | | | | | | | | | | | | | | | 0.2 |
| C1 | Expandable particles 1 | 5 | | | | | | | | 4 | 2 | 7 | | | | | |
| | (FN-185LD) | | | | | | | | | | | | | | | | |
| C2 | Expandable particles 2 | | 5 | | | | | | | | | | | | | | |
| C3 | Expandable particles 3 | | | 5 | | | | | | | | | | | | | |
| C4 | Expandable particles 4 | | | | 5 | | | 5 | | | | | | | | | |
| C5 | Expandable particles 5 | | | | | 5 | | | | | | | | | | | |
| C6 | Expandable particles 6 | | | | | | 5 | | | | | | | | | | |
| C7 | Expandable particles 7 | | | | | | | | | | 2 | | 5 | | 5 | | 1 |
| | (EXPANCEL 461DU) | | | | | | | | | | | | | | | | |
| C8 | Expandable particles 8 | | | | | | | | | | | | | 5 | | 5 | |
| C9 | Thermally expandable | | | | | | | | 5 | | | | | | | | |
| | balloon 9 | | | | | | | | | | | | | | | | |
| | (EXPANCEL 920DE) | | | | | | | | | | | | | | | | |
| E1 | LP-3106 | 2 | 4 | 2 | 2 | 5 | 2 | 2 | 2 | 2 | 5 | 2 | 2 | 2 | 2 | 2 | 2 |
| G1 | 300M | 22 | 20 | 22 | 22 | 20 | 22 | 22 | 22 | 22 | 22 | 22 | 22 | 22 | 22 | 22 | 24 |
| G2 | HAKUENKA CC | 11 | 11 | 11 | 11 | 10 | 11 | 11 | 11 | 11 | 11 | 11 | 11 | 11 | 11 | 11 | 14 |
| B1 | NEOCELLBORN #1000M | 7.5 | 7.5 | 7.5 | 7.5 | 7.5 | 7.5 | 7.5 | 7.5 | 6 | 8.5 | 5 | 7.5 | 7.5 | | | |
| B2 | CELLMIC C-1 | | | | | | | | | | | | | | 7.5 | 7.5 | 4 |
| B′ | CELLTON NP | | | | 1 | | 2 | 7.5 | 3 | | | | | | 7.5 | 7.5 | 4 |
| H1 | Zinc oxide | | | | 1 | | 1 | | 1 | | | | | | | | 1 |
| H2 | Other additives | 2 | 2 | 2 | 2 | 2 | 2 | 2 | 2 | 2 | 2 | 2 | 2 | 2 | 2 | 2 | 2 |
| H3 | KBM-503 | | 0.5 | | | | | | 0.5 | | | | | | | | |

| | | | | | | | | | | | | | | | | |
|---|---|---|---|---|---|---|---|---|---|---|---|---|---|---|---|---|
| Total | 100 | 101 | 100 | 102 | 100 | 103 | 108 | 104 | 97.5 | 103 | 99.5 | 100 | 100 | 108 | 108 | 102 |

Numerical values are in parts by weight

TABLE 2

| | | Example | | | | | | | | |
|---|---|---|---|---|---|---|---|---|---|---|
| | | 1 | 2 | 3 | 4 | 5 | 6 | 7 | 8 | 9 |
| Foaming peak temperature (° C.) of chemical foaming agent | | 157 | 157 | 157 | 150 | 157 | 140 | 128 | 138 | 157 |
| Expansion peak temperature (° C.) of expandable particles | | 152 | 155 | 150 | 125 | 160 | 120 | 125 | 120 | 152 |
| Temperature difference (° C.) | | 5 | 2 | 7 | 25 | −3 | 20 | 3 | 30 | 5 |
| Curing temperature (° C.) | | 180 | 180 | 180 | 180 | 180 | 180 | 130 | 150 | 180 |
| Viscosity (Pa · s) | | 800 | 847 | 773 | 846 | 850 | 772 | 762 | 826 | 768 |
| Expansion ratio (initial) | | 8.6 | 8.5 | 8.5 | 8.5 | 8.3 | 8.5 | 8.1 | 8.8 | 6.5 |
| Leaving uncured test | Expansion ratio | 7.1 | 7.0 | 7.0 | 6.5 | 6.7 | 6.3 | 6.9 | 6.4 | 5.8 |
| 50° C. × 95% × 30 days | Rate of change (%) | 83% | 82% | 82% | 76% | 81% | 74% | 85% | 73% | 89% |
| Adhesion (kPa) | | 41 | 44 | 41 | 45 | 34 | 35 | 35 | 50 | 33 |
| Heat aging resistance | Adhesion (kPa) | 78 | 63 | 97 | 56 | 84 | 73 | 73 | 87 | 75 |
| 80° C. × 30 days | Rate of change (%) | 190% | 143% | 237% | 147% | 247% | 209% | 209% | 174% | 227% |

| | | | | | | | | | |
|---|---|---|---|---|---|---|---|---|---|
| Shower resistance | ◯ | ◯ | ◯ | ◯ | ◯ | ◯ | ◯ | ◯ | ◯ |
| Hat fillability | ◯ | ◯ | ◯ | ◯ | ◯ | ◯ | ◯ | ◯ | ◯ |

| | | Example | | Comparative Example | | | | |
|---|---|---|---|---|---|---|---|---|
| | | 10 | 11 | 1 | 2 | 3 | 4 | 5 |
| Foaming peak temperature (° C.) of chemical foaming agent | | 157 | 157 | 157 | 157 | 142 | 142 | 142 |
| Expansion peak temperature (° C.) of expandable particles | | 90/152 | 152 | 100 | 90 | 100 | 90 | 100 |
| Temperature difference (° C.) | | 5 | 5 | 57 | 67 | 42 | 52 | 42 |
| Curing temperature (° C.) | | 180 | 180 | 180 | 180 | 130 | 130 | 130 |
| Viscosity (Pa · s) | | 764 | 844 | 835 | 822 | 765 | 809 | 850 |
| Expansion ratio (initial) | | 9.0 | 7.8 | 8.5 | 8.5 | 8.5 | 18.5 | 6.5 |
| Leaving uncured test | Expansion ratio | 6.9 | 6.8 | 3.0 | 3.2 | 2.5 | 2.8 | 2.8 |
| 50° C. × 95% × 30 days | Rate of change (%) | 77% | 87% | 35% | 38% | 29% | 33% | 43% |
| Adhesion (kPa) | | 44 | 46 | 45 | 34 | 48 | 35 | 43 |
| Heat aging resistance | Adhesion (kPa) | 93 | 77 | 60 | 58 | 93 | 66 | 76 |
| 80° C. × 30 days | Rate of change (%) | 211% | 167% | 133% | 171% | 194% | 189% | 177% |

| | | | | | | | |
|---|---|---|---|---|---|---|---|
| Shower resistance | ◯ | ◯ | ◯ | ◯ | ◯ | ◯ | ◯ |
| Hat fillability | ◯ | ◯ | ◯ | ◯ | ◯ | ◯ | ◯ |

1. A foamable and curable composition comprising:
a thermally curable elastomer (A),
a chemical foaming agent (B); and
expandable particles (C) having a shell and an enclosed component,
wherein
the chemical foaming agent (B) includes a hydrazine-based foaming agent (B1), and
a peak temperature difference defined by [a foaming peak temperature of the chemical foaming agent (B)]−[an expansion peak temperature of the expandable particles (C)] is −10° C. or more and 40° C. or less.

2. The foamable and curable composition of claim 1, wherein the foamable and curable composition does not contain azodicarbonamide or contains azodicarbonamide less than 1% in the foamable and curable composition.

3. The foamable and curable composition according to claim 1, wherein
the enclosed component includes a hydrocarbon, and
the hydrocarbon has a boiling point of 50° C. or higher and 130° C. or lower.

4. The foamable and curable composition according to claim 3, wherein
the enclosed component includes a hydrocarbon, and
the hydrocarbon has a boiling point of 80° C. or higher and 120° C. or lower and 7 or more and 9 or less carbon atoms.

5. The foamable and curable composition according to claim 1, wherein the enclosed component has an average boiling point of 50° C. or higher and 130° C. or lower.

6. The foamable and curable composition of claim 1, wherein the foamable and curable composition comprises a crosslinking agent (D).

7. The foamable and curable composition according to claim 1, wherein the crosslinking agent (D) includes a peroxide.

8. The foamable and curable composition according to claim 1, wherein the thermally curable elastomer (A) is a diene polymer.

9. The foamable and curable composition according to claim 1, wherein the foamable and curable composition comprises a thermoplastic resin (E) and a plasticizer (F).

10. The foamable and curable composition according to claim 1, wherein a viscosity of the foamable and curable composition at a shear rate of 20 sec⁻¹ at 23° C. is 500 Pa·s or more and 3000 Pa·s or less.

11. The foamable and curable composition according to claim 1, wherein the foamable and curable composition has an expansion ratio of 6.5 times or more and 15 times or less.

12. The foamable and curable composition according to claim 1, which is used for sound insulation.

13. A structure having a portion filled with the foamable and curable composition according to claim 1 or a foamed and cured body thereof.

14. The structure according to claim 13, wherein the structure has a closed cross section,
the closed cross section is filled with the foamable and curable composition or a foamed and cured body thereof, and
the structure is a vehicle body member or an automobile.
